(19) United States
(12) Patent Application Publication
(10) Pub. No.: US 2022/0220933 A1
(43) Pub. Date: Jul. 14, 2022

(54) METHOD FOR DESIGNING AND OPERATING A WIND POWER PLANT, WIND POWER PLANT, AND WIND FARM

(71) Applicant: Wobben Properties GmbH, Aurich (DE)

(72) Inventors: Ralf MESSING, Aurich (DE); Mustafa Onur KIMILLI, München (DE); Stefanie BOTT, Aurich (DE)

(21) Appl. No.: 17/612,125

(22) PCT Filed: May 15, 2020
(86) PCT No.: PCT/EP2020/063692

§ 371 Date: Nov. 17, 2021

(30) Foreign Application Priority Data
May 17, 2019 (DE) 10 2019 113 044.1

(51) Int. Cl. F03D 1/06; F03D 7/02

(52) U.S. Cl. CPC F03D 1/0633; F05B 2240/3062; F03D 7/0224

(57) ABSTRACT

A method for designing and operating a wind power plant for generating electrical power from wind, wherein the wind power plant has an aerodynamic rotor with rotor blades of which the blade setting angle can be adjusted, wherein the rotor blades are populated with a plurality of vortex generators between the rotor blade root and the rotor blade tip, characterized in that the population with the vortex generators in the longitudinal direction of the respective rotor blade is carried out up to a radius position which is determined depending on the air density at a site of the wind power plant. A rotor blade of a wind power plant, to an associated wind power plant and to a wind farm.

### BACKGROUND

### Technical Field

The present invention relates to a method for designing and operating a wind power plant for generating electrical power from wind, wherein the wind power plant has an aerodynamic rotor with rotor blades of which the blade angle can be adjusted, wherein the rotor blades are populated with a plurality of vortex generators between the rotor blade root and the rotor blade tip. Furthermore, the present invention relates to a rotor blade of a rotor of a wind power plant, to a wind power plant and to a wind farm.

### Description of the Related Art

In order to influence the aerodynamic properties of rotor blades, it is known to provide, on the cross-sectional profile of the rotor blades, vortex generators which comprise a plurality of swirl elements running perpendicularly in relation to the surface. The vortex generators serve for generating local regions of turbulent air flows over the surface of the rotor blade in order to effect an increase in the resistance to flow separations. For this purpose, vortex generators swirl the flow close to the wall on the rotor blade, as a result of which the exchange of momentum between flow layers close to the wall and remote from the wall is greatly increased and the flow speeds in the boundary layer close to the wall increase.

Against the background of cost-optimized manufacture, a rotor blade is generally fitted with vortex generators in a standardized manner, that is to say it is populated with vortex generators in the same way for each site.

Wind power plants are subject to a wide variety of environmental conditions depending on their site; in particular, the characteristics of the wind field to which the wind power plants are exposed during diurnal and seasonal changes may differ greatly. The wind field is characterized by a large number of parameters. The most important wind field parameters are average wind speed, turbulence, vertical and horizontal shear, change in wind direction over height, oblique incident flow and air density.

A change in the air density, in particular an increase in the angle of attack on the rotor blade caused by a decreasing air density, is countered by way of the blade setting angle, which is usually also called the pitch angle, being increased starting from a defined power in order to avoid the threat of flow separation in particular in the central region of the rotor blade, which flow separation would otherwise lead to large power losses.

The German Patent and Trademark Office performed a search for the following prior art in the priority application for the present application: DE 601 10 098 T2, US 2013/0280066 A1, WO 2007/114698 A2, WO 2016/082838 A1, WO 2018/130641 A1.

### BRIEF SUMMARY

Provided is a method for designing and operating a wind power plant that is distinguished by more efficient operation of the wind power plant, but also to specify a rotor blade, a wind power plant and a wind farm which allow more efficient operation.

According to one aspect, provided is a method for designing and operating a wind power plant for generating electrical power from wind, wherein the wind power plant has an aerodynamic rotor with rotor blades of which the blade setting angle can be adjusted, wherein the rotor blades are populated with a plurality of vortex generators between the rotor blade root and the rotor blade tip at radius positions in the longitudinal direction. Efficiency of operating the wind power plant is achieved in that the population with the vortex generators in the longitudinal direction of the respective rotor blade is carried out up to a radius position which is determined depending on the air density at a site of the wind power plant.

Provided is adapted population with the vortex generators on the respective rotor blade at a site with a relatively low air density, in order to prevent the occurrence of flow separation on account of the relatively low air density in comparison to prior population of a rotor blade with the vortex generators independently of the site because the vortex generators increase the maximum angle of attack at which a stall occurs. A population of the rotor blade with vortex generators depending on the site, i.e., in a non-standardized manner, can lead to increased production which, overall, may possibly considerably overcompensate for the savings made in respect of production in the case of population independently of the site.

For example, the method can determine that no vortex generators are advantageous for a specific rotor blade up to a predetermined air density, for example said air density ρ_{A}, and population with vortex generators is introduced only when air densities drop below the predetermined air density ρ_{A}.

The population with vortex generators can begin immediately at the rotor blade root or at a position at a distance from the rotor blade root in the longitudinal direction. The population ends in the radius position determined depending on the air density. Continuous or constant population with vortex generators is performed either, that is to say that interruptions in the population are also possible.

In the case of passive elements for influencing flow in the form of vortex generators, “population” is to be understood to mean, in particular, fitting such elements to or on the rotor blade. In the case of active elements for influencing flow, “population” can be understood to mean, in particular, the activation or deactivation of such elements, but also fitting of said elements to or on the rotor blade. Active elements for influencing flow comprise slots or openings for drawing in and/or blowing out air, controllable flaps and the like.

Combinations of active and passive elements for influencing flow can particularly preferably be used as vortex generators. Therefore, in this case, passive vortex generators can be used, for example, in an inner region close to the rotor blade root, while active vortex generators can be used in a region which is situated further on the outside. Therefore, the radius position, up to which the rotor blade is populated with vortex generators, can also be varied during ongoing operation by controlling the active elements for influencing flow and can be matched, in particular, to the air density. At the same time, the complexity of design in comparison with exclusively active vortex generators is kept low owing to the comparatively small proportion of active vortex generators.

The air density is not constant and varies over time. Therefore, an average value, for example an annual average of the air density, or else a minimum of the annual air density is preferably used as a value for the air density. As an alternative or in addition, the geographical height of the site can be included, this having an influence on the air density, as is known. The air density is then preferably calculated from the geographical height and, for example, an average temperature at the site.

The radius position represents the position on a rotor blade along the rotor blade longitudinal axis as the radius of the respective position with respect to an outside radius of the rotor or represents a rotor blade length. The two reference variables outside radius and rotor blade length differ by half the diameter of the rotor blade hub, which may have to be subtracted.

As a result, the relevant position on the rotor blade as the radius position can be indicated by a value in the range of from 0 (zero) to 1 (one). The reason for using the radius for describing a position along the rotor blade is that rotor blades are intended to be mounted on a rotor of a wind power plant in order to fulfil their intended use. Therefore, rotor blades are always permanently associated with a rotor, and therefore the radius is used as a reference variable. The radius position preferably has the value 0 (zero) at the center point of the rotor, that is to say in the rotor rotation axis. The radius position preferably has the value 1 (one) at the blade tip which characterizes the point of the rotor situated furthest on the outside.

Determining the radius position can preferably be performed depending on the air density in such a way that the increase in the angle of attack on the rotor blade caused when the air density decreases and the power loss to be expected due to flow separation is compensated for. Owing to the site-specific design of the arrangement of the vortex generators, which design is dependent on the air density, the occurrence of flow separation can be switched to significantly increased angles of attack. This makes it possible to operate the rotor blade in an optimized angle of attack range.

In a preferred development, determining the radius position at which the vortex generators end can be performed depending on the air density in such a way that an increase in the blade setting angle, which increase is necessary in the case of a relatively low air density, is compensated for. The increase in the blade setting angle or pitch angle can therefore be reduced or even entirely avoided.

In particular, it is provided that arranging the vortex generators is carried out with increasing values for the radius position as the air density decreases. The vortex generators can be arranged over a wider region in the central region of the rotor blade than is the case in the case of a relatively high air density, as a result of which flow separation in the case of low air densities is prevented in the wider central region too. Owing to the occupation of the respective rotor blade with vortex generators which goes beyond an occupation for a relatively high air density, the maximum permissible angles of attack can be increased given a lower air density determined at the site of the wind power plant.

Setting the blade setting angle can preferably be carried out depending on the radius position determined for the population with the vortex generators. As a result, an optimum design can be ensured.

The population of the rotor blade with the vortex generators can preferably be carried out taking into account specific operational management, in particular a specific rated power at which the wind power plant at one site is operated. In respect of operational management, it is conceivable to provide site-dependent rated powers for a wind plant type. For this purpose, increasing the rated power can be implemented by increasing the rated rotor speed. The operation of the wind power plants at the respective rated rotor speeds and rated powers should be performed permanently in a site-dependent manner. Relatively high rated rotor speeds can, in particular depending on the ratio of rated rotor speed and rated power, lead to relatively high tip speed ratios in the region of the rated power and therefore to reduced angles of attack, and consequently the risk of flow separation is reduced. In return, this leads to the population with vortex generators in the radial direction being able to be reduced, and this can, in turn, lead to less noise and to increases in power. Therefore, it may be advantageous to populate wind power plants of a plant type which are operated at different rated powers with vortex generators to different extents in the radial direction.

In this case, the value for the radius position up to which the population of the respective rotor blade with vortex generators is carried out can become greater as the tip speed ratio, which is defined as the ratio of a speed of the rotor blade tip at the rated rotor speed to the rated wind speed when the rated power is reached, decreases.

According to a preferred development, a plurality of blade setting characteristic curves can be stored and one blade setting characteristic curve can be selected from amongst the stored blade setting characteristic curves depending on the rotor position determined for the population with the vortex generators and can be used for setting the blade setting angle.

The wind power plant can preferably be operated at a rated rotor speed depending on the site and the population with the vortex generators can be performed in the longitudinal direction of the respective rotor blade up to a radius position which is determined depending on the rated rotor speed.

In this case, the value for the radius position up to which the population of the respective rotor blade with vortex generators is carried out can become lower as the rated rotor speed increases and in particular as the tip speed ratio simultaneously increases.

In a preferred development, the rated rotor speed can be increased for a fixed but low air density if this is possible for the specific wind power plant and, at the same time as the increased rated rotor speed, the radius position up to which the rotor blade is populated with vortex generators can be reduced when the tip speed ratio increases overall.

In addition to the different environmental conditions at the different sites, wind power plants may also be subject to different general conditions depending on their site. These may be, for example, provisions such as a permitted noise level distance from ambient noise or a sound level which is generated by the wind power plant at a specific distance from the wind power plant during operation that must not be exceeded. For example, sound level requirements of 5 to 6 dB in relation to ambient noise during part-load operation of a wind power plant apply in France.

In order to reduce the sound level, the wind power plants are generally operated at a reduced rated rotor speed, i.e., both with a reduced part-load rotor speed and with a reduced rated load rotor speed, in comparison to the power-optimized operating mode in a sound-reduced operating mode. In order to avoid the threat of flow separation in particular in the central region of the rotor blade, which flow separation would otherwise lead to large power losses, the blade setting angle is increased starting from a defined power.

The radius position up to which the population with the vortex generators in the longitudinal direction of the respective rotor blade is carried out can preferably additionally be determined depending on a sound level to be set at the site of the wind power plant.

In this case, the sound level to be set is selected in such a way that the wind power plant meets sound level requirements at the site of the wind power plant. The population of the rotor blade as far as a radius position which is situated further on the outside in the longitudinal direction of the respective rotor blade allows a smaller blade setting angle to be provided during operation of the wind power plant, in spite of a relatively low rotor speed, in order to prevent flow separations. As a result, the wind power plant can be operated at a rotor speed that is reduced in comparison to a power-optimized operating mode and with a higher power coefficient in a sound-reduced operating mode. This can make it possible to increase the annual energy production of the wind power plant. The increase in the annual energy production may lie in the region of a few percent, for example 2% to 4%.

Sound level requirements which determine the sound level to be set that must not be exceeded may change at a site over time. For example, different sound level requirements may apply at different times, for example at night and during the day or at specific rest times. This and a corresponding share of a sound-reduced operating mode in addition to the power-optimized operating mode in a total operating period of the wind power plant can be taken into account when determining the radius position up to which the population with the vortex generators in the longitudinal direction of the respective rotor blade is carried out.

The method can, for example, provide that a parameter depending on the rotor speed, blade setting angle of the rotor blades and radius position up to which the population with the vortex generators in the longitudinal direction of the respective rotor blade is carried out are iteratively optimized in relation to one another depending on the air density and the sound level to be set at the site of the wind power plant, until a boundary condition is satisfied. The parameter may be, for example, a production quantity generated by the wind power plant in a certain time period, for example an annual energy production of the wind power plant. Here, the share of the respective operating mode in the total operating period can be taken into account. The boundary condition may be, for example, reaching a maximum number of iteration steps or a convergence condition. The convergence condition may be, for example, that the difference between annual energy productions established in two successive iteration steps is lower than a prespecified limit value. This can make it possible to match the rotor speed, the blade setting angle of the rotor blades and the radius position up to which the population with the vortex generators in the longitudinal direction of the respective rotor blade is carried out to one another such that maximum annual energy production is achieved taking into account the air density and the sound level requirements at the site of the wind power plant.

According to a second aspect, provided is a rotor blade having a suction side and a pressure side, wherein a plurality of vortex generators are arranged at least on the suction side between the rotor blade root and the rotor blade tip, wherein arranging the vortex generators in the longitudinal direction of the respective rotor blade up to a radius position is performed depending on a site-specific air density. The population of the respective rotor blade with vortex generators depending on a site-specific air density prevents flow separation and as a result it is possible to reduce or even to entirely dispense with increasing the pitch angle required as a result of the changed air density, and this can lead to greater production overall.

In this case, arranging the vortex generators starting from the rotor blade root, in the direction of the rotor blade tip, up to a radius position of the rotor blade can be restricted by a site-specific tip speed ratio, in particular the radius position can increase from a relatively high tip speed ratio to a relatively low tip speed ratio.

It may therefore be advantageous to make provision for rotor blades of wind power plants of one plant type which are operated at different tip speed ratios, for example on account of different rated powers, to also be populated with vortex generators to different extents in the radial direction in such a way that the lower the tip speed ratio, the further to the outside vortex generators are fitted.

The tip speed ratio is, as described, defined as the ratio of a speed of the rotor blade tip at the rated rotor speed to the rated wind speed when the rated power is reached. The tip speed ratio accordingly depends on the ratio of the rated rotor speed and the rated power. By way of the rated rotor speed and/or the rated power changing, a relatively high or relatively low tip speed ratio can accordingly result. In a third aspect, provided is a wind power plant comprising an aerodynamic rotor with rotor blades of which the blade setting angle can be adjusted, wherein the rotor can be operated at a settable rated rotor speed, and a control system, characterized in that the control system is designed to operate the wind power plant in line with a method according to the first aspect or a refinement thereof described as preferred.

The rotor can preferably have at least one rotor blade according to the second aspect.

In a fourth aspect, provided is a wind farm having a plurality of wind power plants according to the third aspect.

### BRIEF DESCRIPTION OF THE SEVERAL VIEWS OF THE DRAWINGS

The invention will be described in more detail below with reference to one possible exemplary embodiment with reference to the appended figures, in which:

FIG. 1 shows a wind power plant according to the present invention;

FIG. 2 shows a diagrammatic view of a single rotor blade;

FIG. 3 shows, by way of example, different curves for angles of attack on the rotor blade given a specific rated power of the wind power plant over the standardized rotor radius for four different operating situations;

FIG. 4 shows exemplary curves of the lift-to-drag ratio for the four different operating situations of the wind power plant;

FIG. 5 shows exemplary power curves for different operating situations; and

FIG. 6 shows, by way of example, two blade setting angle characteristic curves for two different operating situations.

### DETAILED DESCRIPTION

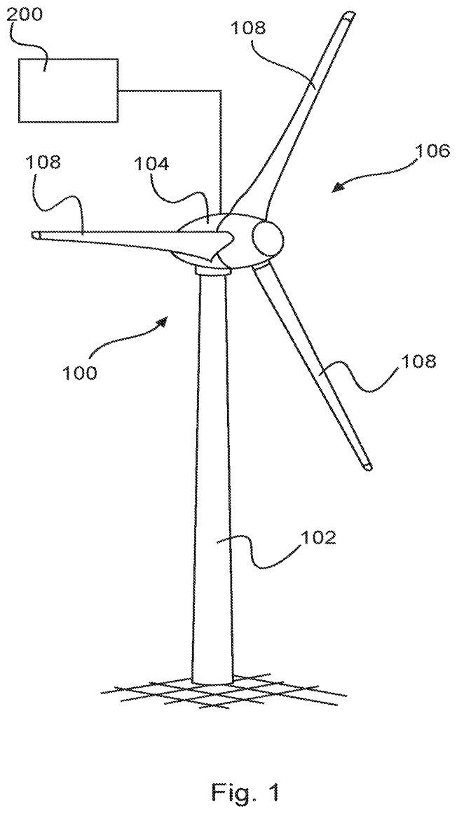

The explanation of the invention on the basis of examples with reference to the figures takes place in a substantially diagrammatic manner, and the elements which are explained in the respective figure can be exaggerated therein for improved illustration and other elements can be simplified. Thus, for example, FIG. 1 illustrates a wind power plant per se diagrammatically, with the result that an arrangement of vortex generators which is provided cannot be seen clearly.

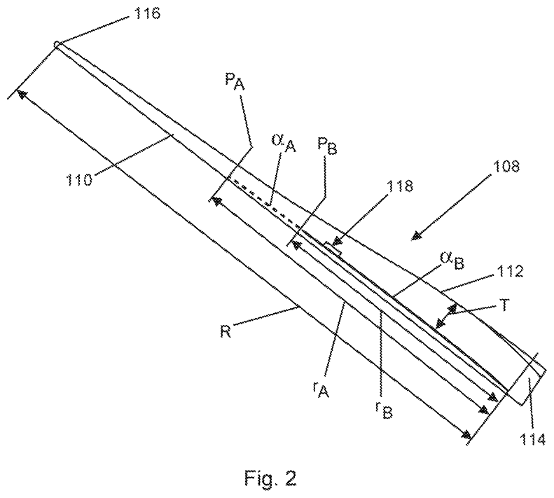

FIG. 1 shows a wind power plant 100 with a tower 102 and a nacelle 104. A rotor 106 with three rotor blades 108 and a spinner is arranged on the nacelle 104. During operation, the rotor 106 is set in a rotational movement by way of the wind and, as a result, drives a generator in the nacelle 104. The blade angle of the rotor blades 108 can be set. The blade setting angles γ of the rotor blades 108 can be changed by pitch motors which are arranged at rotor blade roots 114 (FIG. 2) of the respective rotor blades 108. The rotor 106 is operated at an adjustable rated rotor speed n. The rotor speed n may differ depending on the operating mode. In a power-optimized operating mode, the rotor 106 can be operated at as high a rated rotor speed as possible, whereas the rotor 106 is operated at a relatively low rotor speed in a part-load operating mode.

In this exemplary embodiment, the wind power plant 100 is controlled by a control system 200 which is part of a comprehensive control system of the wind power plant 100. The control system 200 is implemented, in general, as part of the control system of the wind power plant 100.

The wind power plant 100 can be operated in a power-optimized operating mode and optionally also in a part-load operating mode, for example a sound-reduced operating mode, by means of the control system 200. In the power-optimized operating mode, the wind power plant 100, independently of sound level requirements, generates the optimum rated power that can be generated with the wind power plant 100 depending on the air density at the site of the wind power plant 100. In the sound-reduced operating mode, the wind power plant 100 is operated at a rotor speed that is reduced in comparison to the power-optimized operating mode, in order to set a sound level which is less than or equal to a sound level prespecified by sound level requirements. The wind power plant 100 can optionally be designed and operated by means of the control system 200 in such a way that an annual energy production is maximized depending on the air density and while complying with the sound level requirements at the site of the wind power plant 100.

A plurality of these wind power plants 100 may form part of a wind farm. The wind power plants 100 in this case are subject to a wide variety of environmental conditions, depending on their site. In particular, the characteristics of the wind field to which the wind power plants are exposed during diurnal and seasonal changes may differ greatly. The wind field is characterized by a large number of parameters. The most important wind field parameters are average wind speed, turbulence, vertical and horizontal shear, change in wind direction over height, oblique incident flow and air density. Furthermore, general conditions such as sound level requirements made of the wind power plant may differ depending on its site. These may also differ at different times, for example may be different during the day than at night or at rest times.

With a view to the wind field parameter air density, one measure for operating a wind power plant provides for countering the increase in the angles of attack on the rotor blade, which increase is caused by the decreasing air density, by way of increasing the blade setting angle γ, which is also called the pitch angle, starting from a certain power in order to avoid the threat of flow separation in the central region of the rotor blade 108, which flow separation would lead to large power losses. This raising of the blade setting angle γ in this case leads to power losses of the wind power plant 100, but these power losses in general turn out to be smaller than the power losses which would occur as a result of the flow separation occurring at the respective rotor blades 108. Furthermore, provision is made to raise the rated speed at sites with a low air density in order to thereby counter the drop in the tip speed ratio caused by the air density.

It is now proposed to take into consideration a design of the population with vortex generators 118, which design is matched to a site with a relatively low air density ρ_{A}, as is illustrated in FIG. 2 by way of example. The vortex generators 118 which are fitted over an extended region in the central part of the rotor blade 108 depending on the air density ρ_{A} determined at a site of the wind power plant 100 prevent flow separation in the central part and as a result it is possible to reduce or even entirely dispense with the raising of the blade setting angle γ, and this can lead to greater production by the wind power plant 100 overall.

FIG. 2 shows a diagrammatic view of a single rotor blade 108 having a rotor blade leading edge 110 and a rotor blade trailing edge 112. The rotor blade 108 has a rotor blade root 114 and a rotor blade tip 116. The distance between the rotor blade root 114 and the rotor blade tip 116 is called the outside radius R of the rotor blade 108. The distance between the rotor blade leading edge 110 and the rotor blade trailing edge 112 is called the profile depth T. At the rotor blade root 114 or, in general, in the region close to the rotor blade root 114, the rotor blade 108 has a large profile depth T. At the rotor blade tip 116, by contrast, the profile depth T is very much smaller. The profile depth T decreases significantly starting from the rotor blade root 114, in this example after an increase in the blade inner region, up to a middle region. A separation point (not illustrated here) may be provided in the middle region. From the middle region up to the rotor blade tip 116, the profile depth T is almost constant, or the decrease in the profile depth T is significantly reduced.

The illustration in FIG. 2 shows the suction side of the rotor blade 108. Vortex generators 118 are arranged on the suction side. Alternative refinements of the vortex generators 118 as active or passive elements for influencing flow are conceivable. Whereas the vortex generators 118 in the example illustrated are shown arranged on the suction side of the rotor blade 108, vortex generators 118 on the pressure side of the rotor blade 108 with the population are possible as an alternative or else in addition. The placement of the vortex generators 118 can take place in the region of the rotor blade leading edge 110 or else at another position between the rotor blade leading edge 110 and the rotor blade trailing edge. The extent of the population with the vortex generators 118 begins in the region of the rotor blade root 114 and runs in the direction of the rotor blade tip 116.

With respect to the rotor 106, the vortex generators 118 extend in the radial direction up to a position PA or PB on the rotor blade 108. In this case, the respective position PA or PB on the rotor blade 108 is specified as the radius position with respect to a standardized radius r/R. The radius position with respect to the standardized radius r/R represents the position on the rotor blade 108 along the rotor blade longitudinal axis as radius rₐ, r_{b} of the respective position P_{A}, P_{B} with respect to the outside radius R of the rotor 108 or represents the rotor blade length. As a result, the relevant position P_{A} or P_{B} on the rotor blade 108 as the radius position can be indicated by a value in the range of from 0 (zero) to 1 (one).

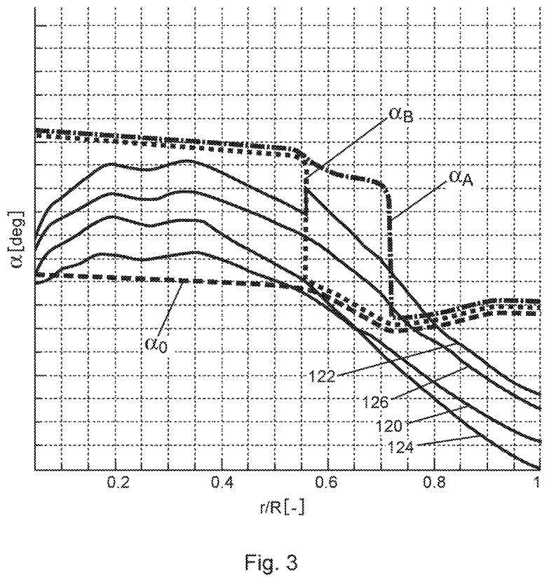

FIG. 3 shows, for four exemplary, different operating situations (case 1 to case 4) which are listed in the following table, by way of example different curves 120 (case 1), 122 (case 2), 124 (case 3) and 126 (case 4) at a power in the region of the rated power for angles of attack α on the rotor blade 108 over the radius position r/R. The operating situations case 1 to case 4 differ from one another in respect of the values for air density ρ_{A}, ρ_{B} and position P_{A}, P_{B} of the population of the rotor blade 108 with vortex generators 118 and a blade setting angle characteristic curve P_{ρA}, P_{ρB} selected for operation.

Table of Operating Situations

| | |
|---|---|
| Case 1 | Air density ρ_{B}, vortex generators up to P_{B}, blade setting angle |
| | characteristic curve P_{ρB} |
| Case 2 | Air density ρ_{A}, vortex generators up to P_{B}, blade setting angle |
| | characteristic curve P_{ρB} |
| Case 3 | Air density ρ_{A}, vortex generators up to P_{B}, blade setting angle |
| | characteristic curve P_{ρA} |
| Case 4 | Air density ρ_{A}, vortex generators up to P_{A}, blade setting angle |
| | characteristic curve P_{ρB} |

Case 1 is based on the air density ρ_{B}, for example the standard air density ρ_{B}=1.225 kg/m³. For this air density, the wind power plant, owing to the vortex generators arranged up to the position P_{B}, can be operated with the preferred blade setting angle characteristic curve PρB, without a stall occurring along the rotor blade.

Cases 2 to 4 are then based on an air density ρ_{A} that is lower than the air density ρ_{B}. In case 2, the configuration of case 1 is adopted, that is to say operating parameters that are otherwise the same are used for operation at the lower air density.

Disadvantageous stalls occur here.

In order to counter these stalls, a blade setting angle characteristic curve PρA is provided in case 3, this ensuring that no stalls occur, but significant production losses likewise occur overall as in case 2 with the blade setting angle characteristic curve PρB.

Case 4 describes a solution in line with which more reliable operation with the preferred blade setting angle characteristic curve P_{ρB} in spite of a low air density ρ_{A} is possible without stalls occurring, owing to the change in the vortex generators up to P_{A}. As an alternative, a blade setting angle characteristic curve which lies between the blade setting angle characteristic curves P_{ρA} and P_{ρB} can be used.

Specifically, FIG. 3 shows, by way of example, various curves 120, 122, 124, 126 for the angle of attack a at a power close to rated power, e.g., 95% of the rated power, of the wind power plant 100 with respect to the radius position r/R for the four operating situations case 1 to case 4. The curve 120 is established for case 1. The curve 122 is established for case 2. The curve 124 is established for case 3. The curve 126 is established for case 4.

Furthermore, the maximum permissible angles of attack α_{A}, α_{B}, and α₀ or stall angles are illustrated by dashed lines. The maximum permissible angle of attack α₀ is established when there are no vortex generators 118 arranged on the rotor blade 108. The maximum permissible angle of attack α_{B} is established when population with vortex generators 118 up to position P_{B} on the rotor blade 108 is provided, this corresponding to a radius position r/R of approximately 0.55 in the exemplary embodiment illustrated. The maximum permissible angle of attack α_{A} is established when population with vortex generators 118 up to position P_{A} on the rotor blade 108 is provided, this corresponding to a radius position r/R of approximately 0.71.

The sudden increases in the maximum permissible angles of attack α_{A}, an at the radius position r/R of approximately 0.71 or 0.55 and the permissible angles of attack α_{A}, an that have risen sharply in the direction of the blade root 114 are caused by the vortex generators 118 that are fitted. The population of the rotor blade 108 with vortex generators 118 switches the flow separation to significantly increased angles of attack α_{A}, an and therefore allows the profile to be operated in a considerably extended angle of attack range.

Without the use of vortex generators 118 up to the radius position r/R of below 0.71 or 0.55, the maximum permissible angles of attack α_{A}, an until this radius range is reached would be significantly lowered, this being indicated in FIG. 3 by the line for the maximum permissible angle of attack α₀. It is clear that the angles of attack α occurring at the air density ρ_{B} in this rotor blade range would even already in case 1, indicated by the line 120, lead to the maximum permissible angles of attack α₀ being overshot and therefore to the stall in the absence of vortex generators 118.

If the wind power plant 100 and the respective rotor blade 108 are operated at the reduced air density ρ_{A}, as is assumed in case 2, without further measures, an angle of attack curve, as illustrated by way of example by the line 122 in FIG. 3, can be established. In case 2, the maximum permissible angles of attack an are overshot between the radius positions 0.55<r/R<0.78 and power-reducing flow separations occur there. The overshootings of the maximum permissible angles of attack an starting from the position P_{B} in the direction of the blade tip 116 typically occur in case 2 since the increases in the angle of attack, caused by the drop in air density, increase from the blade tip 116 to the blade root 114, i.e., the further the profile section is located on the rotor blade 108 on the inside in the radial direction, the higher are the increases in the angle of attack experienced by the profile section. In other words, the overshootings of the maximum permissible angles of attack α_{B} decrease in the direction of the blade tip 116, wherein the greatest risk of the angle of attack being overshot is at the position P_{B}.

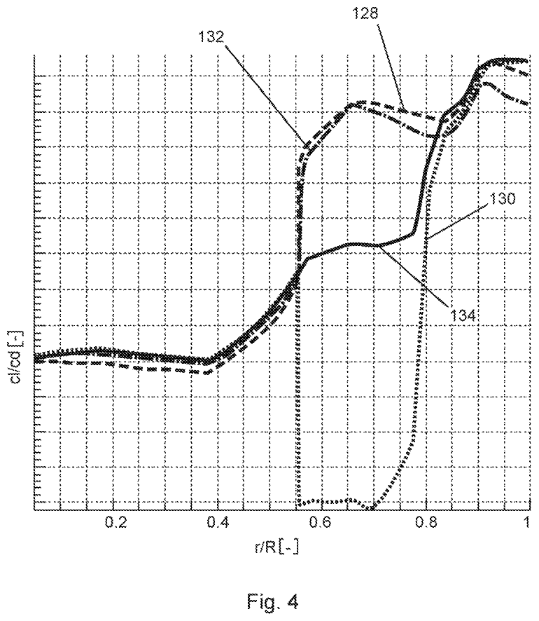

This relationship is clarified by the illustration in FIG. 4. FIG. 4 illustrates exemplary curves 128, 130, 132, 134 for the lift-to-drag ratio for the four different operating situations case 1 to case 4. The curve 128 is established for case 1. The curve 130 is established for case 2. The curve 132 is established for case 3. The curve 134 is established for case 4.

For case 1, it can be seen in the first instance that the lift-to-drag ratios according to the curve 128 up to a radius position r/R<0.55 are small and rise suddenly starting from this radius position r/R and increase toward the outside to the rotor blade tip 116, to higher radius positions r/R>0.55. The low values for the lift-to-drag ratios in the curve 128 are due to the population with vortex generators 118 which generally lead to increased drag coefficients.

The curves 130, 132, 134 of the lift-to-drag ratios in cases 2 to 4 are substantially qualitatively similar to the curve 128 up to the radius position r/R of approximately 0.55. For case 2, it can be seen with reference to curve 130 that the lift-to-drag ratios significantly drop to a low level starting from the position P_{B}, up to which the population with vortex generators 118 is provided in case 2, at a radius position r/R=0.55, this being associated with the flow separation occurring there. In case 2, illustrated by way of example, the flow separation is limited to a central region of the rotor blade 108 in the radial direction, so that in case 2 the lift-to-drag ratios in the outer region r/R>0.8 settle at the level with separation-free flow around the rotor blade region there.

In order to avoid this undesired phenomenon of flow separation on the rotor blade 108, the overshooting of the angles of attack α_{B} is countered according to the prior art by way of the wind power plant 100 increasing the blade setting angle γ starting from a wind speed or a power starting from which the overshooting of the angles of attack α_{B} is expected. Therefore, for example, a blade setting angle γ which is characteristic of the air density ρ_{A}, that is to say a blade setting angle characteristic curve P_{ρA}, is selected. The increase in the blade setting angle leads to a reduction in the angles of attack a on the rotor blade 108 over the entire rotor radius R, so that the angles of attack α are again in a permissible range in the previously critical rotor blade region, this being illustrated by the curve 124 in FIG. 3 for case 3.

However, this procedure has the disadvantage that, as a result of increasing the blade setting angles γ of the rotor blades 108, the so-called pitching, the angles of attack a are also reduced in the outer region of the rotor blade 108, i.e., also in regions where there is typically no risk of flow separation. Therefore, on account of the pitching, the reduction in the angle of attack can lead directly to power losses of the wind power plant 100.

It is therefore proposed that the population with the vortex generators 118 in the longitudinal direction of the respective rotor blade 108 is carried out up to a radius position r/R which is determined depending on the air density ρ_{A} or ρ_{B} of the wind power plant 100 determined at the site. As a result, the described disadvantage of the power loss of the wind power plant 100 which results from the pitching for compensating for the change in the air density can be reduced in particular.

As already discussed further above, the largest increases in the angle of attack occur in the central part of the rotor blade 108 during operation of the wind power plant 100 at relatively low air densities ρ_{A}. This is the case in particular at radius positions which are adjacent in the radial direction to the position P_{B} of vortex generators 118 that are already fitted. In order to counter this, it is provided in the case of operation of the wind power plant 100 at sites with a relatively low air density ρ_{A} to extend the population of the rotor blades 108 with vortex generators 118 radially beyond the position P_{B} up to a position P_{A}. As a result, the risk of flow separations in the central part of the rotor blade, in particular between position P_{B} and position P_{A}, is countered.

A further aspect is that of adjusting the control of the blade setting angles γ at sites with a relatively low air density ρ_{A} during the extended population or fitting of vortex generators 118 on the rotor blades 108 in such a way that the blade setting angles γ are reduced at sites with a relatively low air density ρ_{A}. The angle of attack curve for an exemplary procedure according to this control is illustrated in FIG. 3 by the line 126 for the operating situation case 4. Owing to the population of the respective rotor blade 108 with vortex generators 118 beyond the position P_{B}, the maximum permissible angles of attack as are increased between the radius positions 0.55<r/R<0.71. Therefore, angles of attack α which are in the permissible range are established in this rotor blade section, i.e., between the radius positions 0.55<r/R<0.71, during operation of the wind power plant 100. Furthermore, it is clear that the angles of attack a on the entire rotor blade 108 have risen in comparison to case 3, illustrated by the line 124, this leading to production gains due to an increased power draw, primarily in the outer part of the rotor blade, by the wind power plant 100. The pitch motors are driven by the control system 200.

The population of rotor blades 108 with vortex generators 118 is accompanied by a reduction in the lift-to-drag ratios, as was discussed further above. With reference to the illustration in FIG. 4, the problem of reducing the lift-to-drag ratio by population with the vortex generators 118 is explained for the operating situation in case 4. By way of extending the population with vortex generators 118 up to a radius position r/R=0.71 in position P_{A}, the lift-to-drag ratio up to this position remains at a lower level than is the case in the operating situations case 1 and case 3. However, with suitable design, more power is again generated in the outer region of the rotor blade 108, i.e., a position with a radius position r/R>0.71, this being associated with increases in production which are then established.

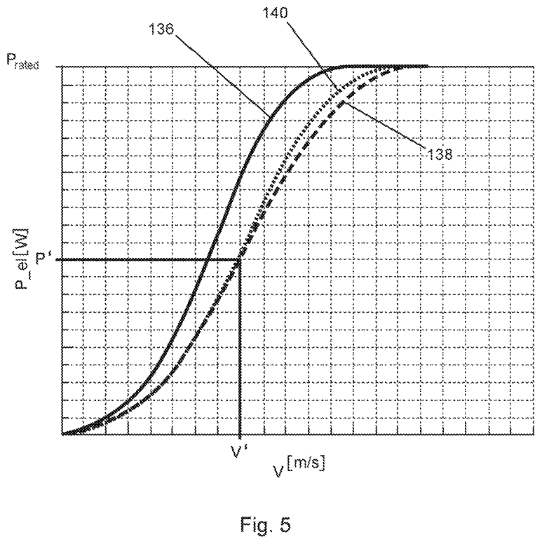

This increase in production due to increasing generation of power in the outer region of the rotor blade 108 is shown by way of example in FIG. 5. FIG. 5 shows, by way of example, different power curves 136, 138, 140 for the operating situations case 1, case 3 and case 4. The power curve 136 is established in case 1, the power curve 138 is established in case 3 and the power curve 140 is established in case 4.

By way of comparing initially the operating situations in case 1 and case 3, which differ only by way of the operation of the wind power plant 100 at different air densities ρ_{A} and ρ_{B}, it can be determined that the power curve 136 drops to power curve 138 when a changeover is made from the relatively high air density ρ_{B} to the relatively low air density ρ_{A}. This sharp drop in the power curve 136 in case 1 to the power curve 138 in case 3 is the result of the reduction in density and additionally the associated increase in the blade setting angle γ for ensuring separation-free flow around the respective rotor blade 108. For case 4, an increased power draw by the wind power plant 100 is established starting from a wind speed v′ and a power P′. When this power P′ is reached, according to case 4, with population of the respective rotor blade 108 with vortex generators 118 up to the position P_{A} depending on the air density ρ_{A} determined at the site of the wind power plant 100, the control of the blade setting angle γ is based on a blade setting angle value that is reduced in comparison to the blade setting angle value that is used as a basis for control of the blade setting angle γ in case 3. This power draw, which is increased until the rated power P_{rated} is reached, in case 4 leads to the production gains by way of which the increased drag in the region of the additional population by vortex generators 118 beyond position P_{B} up to position P_{A} can be compensated for.

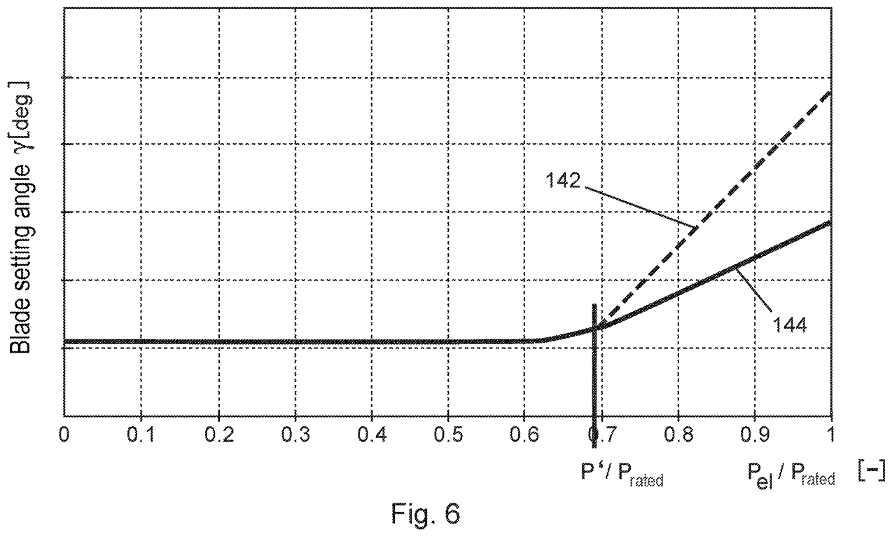

FIG. 6 shows, by way of example, two blade setting angle characteristic curves 142, 144 for two different operating situations. The blade setting angle characteristic curve 142 is based on the operating situation in case 3 of control of the blade setting angle γ. The blade setting angle characteristic curve 144 is based on the operating situation in case 4 of control of the blade setting angle γ by the control system 200. As can be seen from the curves 142, 144, the wind power plant 100 in case 4 can be operated with a smaller increase in the blade setting angle γ than is possible in case 3 when a standardized power P′/P_{rated} is reached.

In case 3, starting from the standardized power P′/P_{rated} with site-independent population of the rotor blade 108 with vortex generators 118 up to the position P_{B}, the relatively low air density ρ_{A} prevailing at the site of the wind power plant 100 is countered by the pitching with large blade setting angles γ. In case 4 however, starting from the standardized power P′/P_{rated} with site-dependent population of the rotor blade 108 with vortex generators 118 up to the position P_{A}, pitching with smaller blade setting angles γ is rendered possible, as a result of which the reduction in the angle of attack turns out to be smaller.

A further aspect takes into account that site-dependent rated powers P_{rated} are provided for operational management for one wind power plant type. In this case, the rated power P_{rated} can be increased by increasing the rated speed. Given the same power, relatively high rated speeds lead to relatively high tip speed ratios in the region of the rated power P_{rated} and therefore to reduced angles of attack α. The risk of flow separation is accordingly reduced.

In return, this leads to fitting of vortex generators in the radial direction being able to be reduced, and this can lead to less noise and to increases in power. It may therefore be advantageous to make provision for the rotor blades 108 of wind power plants 100 of one plant type which are operated at different rated powers P_{rated} to also be populated with vortex generators 118 up to different positions P_{A}, P_{B} in the radial direction in such a way that the lower the rated power P_{rated} or rated rotor speed, the further to the outside vortex generators 118 are fitted.

As an alternative or in addition to the rated power P_{rated} or rated rotor speed, a further suitable reference variable which is used for adjusting the population with the vortex generators 118 is accordingly the tip speed ratio of the wind power plant 100. When the rotor speed is constant and the power is relatively low, this leads to a relatively high tip speed ratio, wherein the radius position r/R up to which the rotor blade 108 is populated with vortex generators 118 is reduced, that is to say is moved closer to the rotor blade root 114, based on this relatively high tip speed ratio. Accordingly, the radius position r/R can be increased, that is to say moved closer to the rotor blade tip 116, with a dropping rotor speed and a constant power.

If both the rotor speed and the power drop, the ratio determines whether the tip speed ratio ultimately drops or increases. The question of whether the tip speed ratio drops or increases is not clear without more precise information. The ultimately increasing or dropping tip speed ratio can then preferably be used to determine the radius position r/R up to which the rotor blades are populated with vortex generators.

The population of the rotor blade 108 with vortex generators 118 can optionally also be additionally carried out depending on a sound level to be set at the site of the wind power plant 100. For example, the production quantity or another parameter depending on the rotor speed, blade setting angle of the rotor blades and radius position up to which the population with the vortex generators in the longitudinal direction of the respective rotor blade is carried out can be iteratively optimized in relation to one another depending on the air density and the sound level to be set at the site of the wind power plant, until a boundary condition is satisfied. The boundary condition may be, for example, that the difference between production quantities established in two successive iteration steps is lower than a prespecified limit value. This can make it possible to achieve a maximum production quantity not only taking into account the air density but additionally also the sound level requirements at the site of the wind power plant.

1. A method for operating a wind power plant for generating electrical power from wind, wherein the wind power plant has an aerodynamic rotor with a plurality of rotor blades of which the blade setting angle can be adjusted, the method comprising determining a population of a plurality of vortex generators based on an air density at a site of the wind power plant, wherein the population is from the rotor blade root up to a radius position in a longitudinal direction of the respective rotor blade.

2. The method as claimed in claim 1, wherein determining the population comprises determining the radius position based on the air density such that a power loss to be expected on account of an increase in an angle of attack on the rotor blade caused by a decreasing air density is compensated for.

3. The method as claimed in claim 1, wherein when the air density decreases, the determining the population comprises determining the radius position depending on the air density in such a way that an increase in the blade setting angle is compensated for.

4. The method as claimed in claim 1, comprising arranging the plurality of vortex generators in the population of the respective rotor blade with increasing values for the radius position as the air density decreases.

5. The method as claimed in claim 1, comprising setting the blade setting angle depending on the radius position determined for the population with the plurality of vortex generators.

6. The method as claimed in claim 1, comprising operating the wind power plant, and wherein determining the population further comprises determining the population further based on a specific rated power at which the wind power plant is operated.

7. The method as claimed in claim 6, wherein a value for the radius position up to which the population of the respective rotor blade with the plurality of vortex generators becomes greater as a tip speed ratio decreases, wherein the tip speed ratio is defined as a ratio of a speed of the rotor blade tip at the rated rotor speed to the rated wind speed when the rated power is reached.

8. The method as claimed in claim 1, comprising storing a plurality of blade setting characteristic curves, and selecting one blade setting characteristic curve from amongst the stored blade setting characteristic curves depending on the radius position determined for the population with the vortex generators, and using the one blade setting characteristic curve for setting the blade setting angle.

9. The method as claimed in claim 1, further comprising operating the wind power plant at a rated rotor speed depending on the site, and determining the population of the plurality of vortex generators depending on the rated rotor speed.

10. The method as claimed in claim 1, wherein the radius position is determined depending on a sound level at the site of the wind power plant.

11. A rotor blade comprising:
a suction side and a pressure side, and
a plurality of vortex generators arranged at least on the suction side between the rotor blade root and the rotor blade tip, wherein the plurality of vortex generators are arranged in a longitudinal direction of the rotor blade up to a radius position depending on a site-specific air density.

12. The rotor blade as claimed in claim 11, wherein arranging the plurality of vortex generators starting from the rotor blade root, in a direction of the rotor blade tip, up to a radius position of the rotor blade is restricted by a site-specific tip speed ratio.

13. A wind power plant comprising:
an aerodynamic rotor,
a plurality of rotor blades coupled to the aerodynamic rotor, wherein blade setting angles of the plurality of rotor blades are adjustable, wherein the aerodynamic rotor is configured to be operated at a settable rated rotor speed,
a plurality of vortex generators on each rotor blade of the plurality of rotor blades, and
a control system, wherein the control system is configured to determine a population of the plurality of vortex generators on each rotor blade based on an air density at a site of the wind power plant, wherein the population is from a rotor blade root up to a radius position in a longitudinal direction of the respective rotor blade.

14. The wind power plant as claimed in claim 13, wherein the rotor has at least one rotor blade as claimed in claim 11.

15. A wind farm comprising a plurality of wind power plants as claimed in claim 13.

16. The rotor blade as claimed in claim 12, wherein the radius position increases from a relatively high tip speed ratio to a relatively low tip speed ratio.
